(19) United States
(12) Patent Application Publication
(10) Pub. No.: US 2005/0131728 A1
(43) Pub. Date: Jun. 16, 2005

(54) System and method of supplying surface coverings and services

(75) Inventor: Harold Burton Tyreman, Strongsville, OH (US)

Correspondence Address: THE GLIDDEN COMPANY, 15885 WEST SPRAGUE ROAD, STRONGVILLE, OH, 44136, US

(73) Assignee: The Glidden Company

(21) Appl. No.: 10/983,385

(22) Filed: Nov. 8, 2004

Related U.S. Application Data
(60) Provisional application No. 60/518,213, filed on Nov. 7, 2003.
(60) Provisional application No. 60/624,077, filed on Nov. 1, 2004.

(51) Int. Cl. G06F 17/60

(52) U.S. Cl. 705/1

(57) ABSTRACT

A method of providing covering material may comprise providing at the point of sale the product while also providing a volume discount plan, a business resource service; and a service discount plan. The volume discount plan allows the applicator or installer of the product to establish a goal for purchases of the product over a specified period of time. Achieving or exceeding the a goal qualifies the applicator for the volume discount. The business resource service assists the applicator or installer on the business side and the administrative side of their business. The service discount plan provides business services on a volume discount basis to provide improved business performance.

This application claims the benefit of priority under 35 U.S.C. §119(e) of provisional application Ser. No. 60/518,213 entitled “SYSTEM AND METHOD OF SUPPLYING PAINT AND SERVICES,” filed on Nov. 7, 2003, and of provisional application Ser. No. 60/to be assigned, entitled “SYSTEM AND METHOD OF SUPPLYING PAINT AND SERVICES,” filed on Nov. 1, 2004 the disclosures of both of these applications are incorporated herein in their entirety.

### FIELD

The present invention relates to a system and method of supplying colored surface coverings such as paint, stain, varnish, wallpaper, carpeting, ceramic tiles, masonry, bricks and the like and services to applicators or installers to improve the profitability for the their business. Also included are the various tools of the process and system to assist in achieving improved application efficiency.

### BACKGROUND

Numerous industries provide tailored reward or incentive programs for their buyers or purchasers. For example the credit card industry has programs for money back or reward credits redeemable for goods or services. Also the airline industry has the frequent flyer programs and the hotel industry has bonus programs to encourage purchasers to utilize the same hotel chain when traveling or to encourage travel agents to book a particular hotel chain for their customers. A particular example of this is U.S. Pat. No. 5,483,444 assigned to Radisson Hotels International, Inc. for a system for awarding credits to persons who book travel-related reservations. This computerized system provides incentives for travel agents and similar persons to book particular travel-related reservations. The system achieves this by awarding cumulative credits to travel agents based upon bookings of travel-related reservations. The system receives a booking format which identifies a travel-related reservation. The system further receives a code which identifies a travel agent or other person who entered the travel-related reservation. Upon receiving the travel-related reservation, the system assigns cumulative credits to the travel agent identified by the code based upon the travel-related reservation. Travel agents can thus build up credits over time based upon their bookings of travel-related reservations and use those credits to receive a particular award or prize.

Numerous types of colored surface coverings such as wallpaper, paint, stain, varnish, carpeting, ceramic tiles, masonry, bricks and the like can be applied by the do-it-yourselfer (“DIY”) or by applicator or installer contractors. The colors for such coverings range from clear coatings for special effects painting to deep tint colors in paints and various patterns of various colors for wallpaper, carpeting, ceramic tiles, masonry, bricks. The applicator or installer (hereinafter referred to as “applicator”) contractors' service businesses can range from small business entities to larger businesses. Also the property owners of commercial and/or industrial properties may employ or hire application or installation service personnel to apply such colored surface coverings for their properties. Although wallpaper usually is applied to interior building surfaces, paints, varnishes, and stains, carpeting, ceramic tiles, masonry, bricks can be applied on interiors and exteriors horizontal and vertical surfaces of building structures of all sorts. The various sorts of structures painted include without limitation commercial, residential, industrial, and multi-use situations. In most of these for the application contractor the cost of the colored covering material and the application speed are factors in determining the payback of profit for the contractor and the cost to the property owner or leaseholder.

The application contracting business like that of paint contractor is an activity that involves more than the cost of the covering material itself. It involves application devices, selection of appropriate types and quantities of covering material, the time for application of the covering material, and the time and costs of administering and running a contracting business. For all types of application contractors like painters, the efficiency of the activity can be improved by improved utilization of the covering material, quicker application of the covering material, and reduced number of call backs to the job for any defects. Also the contractor's business concerns include, for example, how and where to find and use services such as support services for the business and the people in the business. A few nonexclusive examples include business support services such as bid proposal documentation, paint color analysis, insurance needs and, where possible, group purchasing systems to reduce the cost of doing business.

The present invention provides a system and process for improving the utilization of the covering material and/or reducing the application time of the covering and assisting the application contractor to find and procure various business services to reduce or minimize the time spent by the contractor on activities other than application of the covering material. This results in maximizing the time spent on application activities, like painting which is the actual money generating activity of the applicator contracting business. The result provides a higher payback to the contractor. The payback can be a savings in time and/or money and improved profitability for the contractor.

### SUMMARY OF A FEW ASPECTS OF THE INVENTION

The desirability may exist for providing a multifaceted method and system at least to give volume discounts on purchases over time for surface covering materials that require application to adhere to the surface purchased at point of sale (POS) outlets for use on residential and/or commercial and/or industrial jobs by contractors. Also the method and system provides for one or more of the following:

i) instruction on the efficient utilization of the covering material to reduce labor costs in the application of the covering material,
ii) providing color visualization computer software to visualize the utilization of the colored covering material,
iii) providing color matching facilities,
iv) providing discount service plan,
v) providing business resource service, and
vi) providing leads of application jobs for the covering material.

The desirability may particularly exist for a multifaceted method and system at least to provide volume discounts on purchases over a specific time for covering material such as paints. varnish, stains, wallpaper, carpeting, ceramic tiles, masonry, and bricks and application accessories to contractors for application and/or remodeling and/or construction jobs, while also providing business resource service or clearing house and discount service purchasing opportunities.

One embodiment of the present invention is a method of supplying covering materials through a system of transactional recordation of purchases over time to apply a volume discount rebate while also providing: for utilization of a business resource service for the efficient use of the material, for addressing general business service needs, and for discount service plan for group purchasing opportunities.

Another exemplary aspect of the invention is a method and system of providing paint and painting materials and accessories including a volume discount for purchases over time, while also providing business resource services to the user to reduce the expenditures or time for professional utilization of these goods, and while providing discount services of group purchasing discount possibilities. The business resource services can include providing a variety of paints with a range of colors, color consistency, uniform finish; providing color visualization computer software to visualize the utilization of the paint, providing instruction to match the product to the painter's need, providing color matching facilities, providing instruction on reducing material and labor costs; providing any combination of two or more of these to improve painting efficiency by at least one of lowering the cost of paint and/or shortening the time of application on a per job basis to the painter.

Another embodiment of the present invention is a method of providing paint, comprising: segmenting the market into segments for providing color tools and services to a user that provides inspiration and enhanced curb appeal; providing information and/or instruction for competence in color accuracy and consistency; providing visual effect software; providing products and services that save time and improve cycle time/turns of the user; and providing business assistance tools to support home builders sales initiatives.

Another embodiment of the present invention is a kit for supplying paint and services to the painter, comprising: job estimator, bid calculator, and business planning tool to determine paint utilization over a period of time, and color visualization computer software to visualize the utilization of the paint.

It should be understood that the invention could be practiced without performing one or more of the aspects, objects, and/or advantages described herein. Other aspects will become apparent from the below-described detailed description.

### BRIEF DESCRIPTION OF THE DRAWING

In addition to the arrangements depicted above, the invention could include a number of other arrangements, such as those explained hereinafter. It is to be understood that both the foregoing description and the following description are exemplary. The accompanying drawing is included to provide a further understanding of the invention and is incorporated in and constitutes a part of this specification. The drawing illustrates exemplary embodiments, which together with the description, serve to explain certain principles.

FIG. 1 is an exemplary schematic illustration of an exemplary method of the present invention.

### DETAILED DESCRIPTION OF A FEW EXEMPLARY ASPECTS OF THE INVENTION

In an exemplary embodiment of the method of the present invention, central concerns of an applicator or installer for covering materials are addressed. These include: the visual effect, product performance, and profitability. The visual effect refers to the variety and the quality of the colors for the covering materials. The applicators and installers who purchase covering materials at the point of sale are looking for more than one of: a range of color choices, color consistency, a uniform finish, and products that are easy to apply and touch up is necessary. In addition to the visual effect, the applicators and installers need well performing products tailored to their projects and jobs. This includes consistent quality for the covering material and user friendly customer service. The visual effect factor and the performance factor result in profitability for the applicators and installers. The variety of products and services to assist the applicators and installers maximize the value of their investment and help them grow their margins by driving out material and labor costs. The visual effect factors and performance factors to drive profitability going to the exemplary embodiment of the method of the present invention can involve segmenting the applicator and installer businesses into various segments. A non-exclusive example of such segmentations could be commercial contractors, industrial maintenance, property services, new construction, and residential applicators and installers. Particular features of the embodiment of the present invention regarding the business resource services and/or the discount service plan can be tailored to the particular segment.

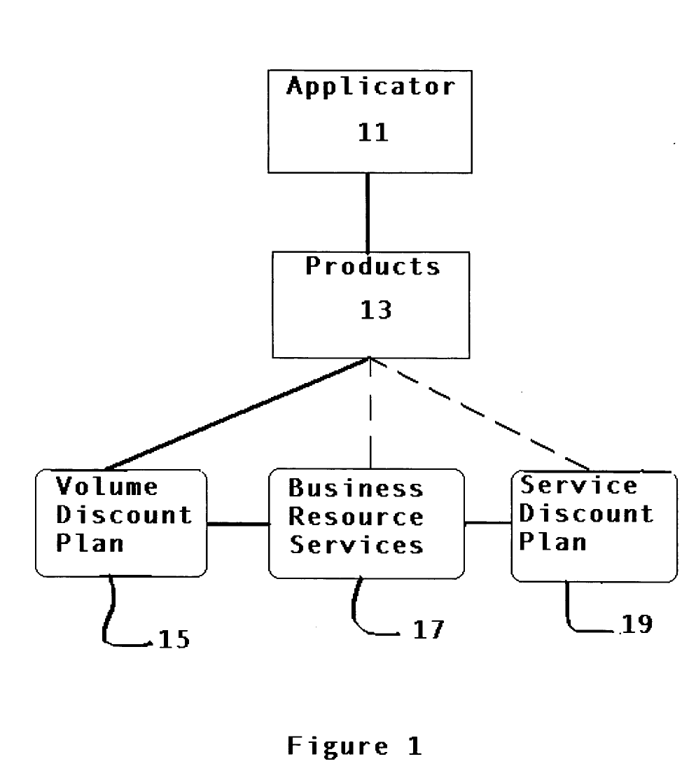

In FIG. 1, the applicators 11 purchase and utilize the products 13. The applicators purchasing of the products 13 can also include the volume discount plan 15 which is available to applicators 11 by declaring a goal of purchases over a specified period of time for the program. In addition, the applicators 11 can also utilize the business resource services 17 when they are a part of the volume discount plan 15. Also, the applicators 11 on the purchase of product 13 can utilize the service discount plan 19 when a part of the volume discount plan 15. Of course, the business resource services 17 and discount service plan 19 can also be offered separately from the volume discount plan 15 as indicated by dashed lines.

The exemplary embodiment of the present invention also provides a variety of covering materials of many grades such as premium, high quality, quality, contractor, commercial, and economical for a large assortment of types of products such as, for paints, colors, finishes, sheens, and textures. Nonexclusive examples include colors ranging from white to a substantial number of colors from the spectrum of colors. Clear can also be included. Substantial refers to up to 80 or more percent of the possible colors of the spectrum. Numerous sheens include for example flat, eggshell, gloss, semi-gloss, and satin type finishes. For wallpaper, carpeting, ceramic tiles, masonry, and bricks numerous textures, fabrics, colors, patterns and finishes such as those known to those skilled in the art can be provided. Also along with the covering materials the application tools and devices can be provided in the inventory of product offerings for the applicator. Nonexclusive examples of paint products include: VOC compliant, alkyd enamels, primers coatings that level-out and hide drywall joints with one coat, monochromic grays, 100% acrylics, high solids and high build exterior paints with wide application temperature latitude, anti-slip floor paints, coatings for wood decks, fences and railings, and marking paints and traffic paints waterborne and solvent borne paints, and stains, paint strippers including water borne paint strippers, and graffiti removers surface tolerant epoxies, acrylic aliphatic polyurethanes, zinc rich coatings, epoxy anti-corrosive coatings, penetrating sealers, and surface tolerant mastics. Along with these products, various application tools and devices can be provided in the inventory such as for paints paint brushes and roller application tools, spray equipment including guns, tips, and hoses; tapes, adhesives, and caulks, ladders, dropcloths, and roll plastic. Further nonexclusive examples of paint products are such as without limitation the following types:

Alkyd enamel product which combines the genuine application and durability of alkyds with the speed and ease of acrylic enamels, specifically formulated with Advanced Alkyd Technology, a development that links oil to water to provide genuine alkyd enamel finish with excellent block resistance. An ultra smooth, low odor, fast drying paint product. The fast drying is sufficient enough to allow three coats to be applied in one day. This development lets painters complete a job without having to tear down and set up again. Plus, the low odor translates into a work environment relatively free of dangerous fumes- allowing day-to-day activities to continue without disruption. Any tint from the tint line of DeVoe Paints can be added for color. The product is less yellowing than other alkyd paint products. Painted surfaces, including trim, doors, doorjambs, windows and cabinets, piping and structural steel, stay whiter longer. Not only is the product longer lasting, it is water reducible, meaning painting tools can be cleaned up with simple soap and water. Also the product meets the anticipated VOC (volatile organic compounds) requirements It is suitable for use in both exterior and interior settings and can be applied residentially, commercially, and industrially.

Also coatings and products associated with application like that of paint or with paint can be provided. A few nonexclusive examples include coating products such as a wide range of architectural paints, stains, industrial coatings, waterborne can coatings, and caulks & adhesives.

Other paint products that can be provided include those like:
Lifemaster 2000 paint which is a premium low odor and no VOC (when un-tinted) interior wall & ceiling paint that is Green Cross Certified. It is specially formulated to provide exceptional hiding and washability, and is an outstanding solution for painting occupied spaces where odor is a concern. Less downtime saves valuable time and money. Dulux Fortis paint is a premium 100% acrylic exterior system that provides lasting beauty and protection. With exceptional weather resistance, fast one-coat application, and quick curing at temperatures as low as 35 degrees, Dulux Fortis paint is the premier solution for a wide range of exterior applications.

The volume discount plan allows applicators to provide their goals over a specified period of time for their need of covering materials. This register of goals can be over any period of time such as monthly, quarterly, semi-annually or annually. For example the need and prospective purchases of covering material can be for a 12 month period of time. Over this period of time the applicator's purchases of covering materials and possibly accessories in the plan over the specified time, in this case 12 months, is tracked by the supplier. These materials are usually supplied through POS outlets. Upon the applicator achieving or exceeding the goal of purchases within the specified time, the applicator receives the quantity or volume discount. For the discount, the more the purchases exceed the goal for the specified time period, the higher the percentage of the discount can be. This higher amount can be percentages over the goal for example as in the chart below:

| 12 Month Purchases | Volume Discount % |
|---|---|
| Above goal to Double goal | X |
| Double to triple goal | X + 1 |
| Triple to Quadruple goal | X + 2 |
| Quadruple to Quintuple goal | X + 3 |
| Quintuple to Sextuple goal | X + 4 |

The tracking of purchases can be by a paper record such as a brochure, card, or booklet on or in which the purchases are recorded for at least that specified period of time. The tracking instrument can also be a computer record associated with the sale recording devices at the POS. For instance the computer software can be part of a computerized cash register. Any of the software and recording type cash registers known to those skilled in the art can be used similar to those from NCR Corporation or IBM Corporation. Recording the sale as part of goal tally can be similar to that for recording credit card or debit card sales as known to those skilled in the art.

The computer tracking record can provide periodic status reports that can be sent to each registered applicator. The status reports like the paper tracking record can include other information. This can include a SWOT analysis of Strengths, Weaknesses, Opportunities, and Threads for the applicator's business. The Strength analysis can include one or more of: time in business, estimating skills, strong industry connections, Safety and Health awareness and training, and strong reputation. The Weaknesses analysis can include one or more of: depth of qualified applicators, buying power of business services and employee benefits, narrow industry focus, and cyclical nature of business. The Opportunities analysis can include one or more of: utilize supplier buying power, expand loyal customer base, develop new market leads, train employees on new products, improve closing rate/turn rate and industry analysis. The threat analysis can include one or more of: key employee departure, price competition driving down margin, rising business costs, and government regulations. Also the record can include a purchasing history to indicate the applicator's more active areas in narrower time segments than the original specified time for the goal. Also additional subsequent periods of time similar to that for the goal can be included.

Optionally the volume discount program can include a second tier. This would be a supplemental volume discount based on increased volume of purchases over those for a prior specified period of time. The time period can be the same as the time period set for the establishment of the goal for purchases. If the period of time for the goal is 12 months then the time period for the supplemental time period can be a subsequent 12 month period from that for establishing the goal. Of course, the time periods from that for establishing the goal and the supplemental discount can also be different. This supplemental discount can be calculated in a manner such as that shown in the table below:

| | | | | |
|---|---|---|---|---|
| Volume Discount + | Total | × | Discount | Discount |
| Supplemental volume | Purchases | | Percentage | payout |
| discount calculation | $ | × | Y % | = $ + Y % $ |
| | Purchases | × | Supplemental | + |
| | Above Prior | | Discount | |
| | Year | | Percentage | |
| | Δ $ | × | Y + 1% | = $ + Y + 1 |

Where $ is the variable of amount of dollars for the specified factor

For business resource services a color simulation program allows visualization of the color of the covering material with the color of surrounding objects for the applicator's use. With the products of varying colors such as paints, stains, varnishes and wallpaper the color simulation program can include color boards prepared by color designers for the supplier of the covering materials. These allow visualization of color schemes for the job prior to the application of the covering material. The simulation also can allow experimentation with color on any of the applicator's projects for commercial, industrial, multi-family residential and the like.

Also the business resource service can include color visualization computer software. This software available from ICI Paints as ColorConnections or Color@ home software allows photographs of the job to be colorized. Such software can be supplied on any medium known to those skilled in the art such as, without limitation, discs like CDs or DVDs or jump drives or can be provided as a web based program from a web site on a server linked to the internet or the world wide web. This software enables customers of the applicator to visualize color schemes for their use. This software provides color options to satisfy customer preferences so they have greater confidence in the final color selection. This assists applicators in building greater value in their businesses. This software can also enable the creation of customized professional looking business forms to increase closure of a sale and generate more referrals.

The business resource service can also include color matching service that takes paint films from color swatches or chips or painted surfaces and matches the color through analytical methodology such as infrared spectrophotometry.

Another item of the business resource service can be the color palette layout in the form of fan decks of color chips or swatches or the chips or swatches themselves in a color card center. The palette can have bright, clean, muted, off-white, neutral, and interior palettes.

The planned painting program can be another item of the business resource service that reduces maintenance painting costs for the applicator's customers, and differentiates the applicator from other applicators. The planner allows for a site survey of the property for the job. Also the planner provides for developing systems specifications and painting priorities based on survey results. The planner also allows for presenting specifications and development of budgets and painting schedules for up to 12 months. Also the planner allows for an annual review of planned painting programs and new paint schedules with customers.

Additionally the business resource service can include on-line internet or world wide web services. These services can provide personalized technical specifications including such items as: product data sheets and Material Safety Data Sheets, print or download industry standard formats, and store project details in a secure area of the system.

The business resource service can also include the covering materials specifications for custom specifications for exterior and interior capital improvement projects. Also capital project supervision can be provided to ensure compliance to specified scope of work schedule. Also inspections and field service can be provided to assist in coatings recommendations, analysis, and specifications. Another feature of the service can be technical assistance and product training. Also assistance at any requested pre-bid meeting can be arranged for the purpose of coatings recommendations and consultation.

Additionally a discount service plan can be provided to the applicator contractors on a group basis to take advantage of group purchasing discounts or volume discounts. Useful features possible for this plan include: vehicle leasing, advertising and promotional items, cellular services, safety supplies, custom signs, hotel discounts, equipment rentals or leasing, computers and office equipment, vehicle maintenance, office supplies, insurance, and employee service. For instance the cost of and accessibility to medical insurance has become an increasingly serious issue for many Americans, most of whom rely on their employer for coverage. However, offering adequate health insurance coverage to employees can be particularly challenging for smaller businesses with limited resources such as contracting business.

One such feature of the discount service plan can be access to an insurance provider as a group such as access to Marsh Advantage America's HealthInsure Answers, a comprehensive brokerage service with access to a wide variety of health insurance products and related services to suit the needs of the discount service purchasing membership.

Such a business service adds value to painting contractors business and find solutions for a challenging problem. Such a plan allows painting contractors to gain a distinct advantage in recruiting, retention and employee satisfaction in regards to the industry which typically does not offer insurance or have plans that are less than adequate. Such a plan allows members to have access to product choices enabling supplements to their current group or individual health insurance coverage or to create a comprehensive benefits package for employees and their families with various options. Such plans can include for instance:
Group Major Medical—For any contractor who currently has a group medical plan in place and would like to research alternatives to his plan.
Individual Major Medical—For members and their employees who don't need or don't want a Group plan.
High Risk Major Medical—There are 30 states that offer a major medical plans to their citizens who applied for insurance through the traditional market and were denied coverage due to existing health conditions.
Limited Medical (sometimes referred to as “mini-medical”)—This limited plan offers a scheduled reimbursement for certain medical services, generally including doctor's office visits, emergency accidents, surgical procedures and first hospital admission, typically for lower prices.
Discount Health—Basic—Provides discounts on such services as vision, prescriptions and dental services.
Discount Health—Plus—In addition to offering discounts found in the “Basic” plan, the option includes pre-negotiated discounts to a network of physicians and hospitals.
Prescription Drug Plan—Provides a $10/$15 co-pay for generic drugs and pre-negotiated discounts for brand name drugs where such a plan could have guaranteed acceptance with even no lifetime maximums.
Term Life Insurance—Rating and electronic enrollment can be provided through a company such as Safeco Life Insurance Company. A person can apply for a policy up to a $2 million face amount.
Discount Dental—Provides pre-negotiated discounts to a national network of dentists.
Commercial Property and Casualty—For any contractor who wants to secure a quote on their Business Owners Policy.
Of course such plans or products and services offered would be subject to the terms and conditions of the governing carrier's or vendor's policies or documents where additional restrictions may apply and some products may not be available in all states.

It will be apparent to those skilled in the art that various modifications and variations can be made to the methodology. Thus, it should be understood that the invention is not limited to the examples discussed in the specification. Rather, the modifications and variations are intended to be covered.

1. Method of supplying covering materials and services to users through POS outlets, comprising:
a) providing a variety of grades of covering material,
b) providing a volume discount program with the purchase of covering materials over time, and
c) providing at least one of:
i) instruction on the efficient utilization of the covering material to reduce labor costs in the application of the covering material,
ii) providing color visualization computer software to visualize the utilization of the colored covering material,
iii) providing color matching facilities,
iv) providing discount service plan,
v) providing business resource service, and
vi) providing leads of application jobs for the covering material.
whereby a) through c) lower the cost of covering material or shorten the time of application on a per job basis to the applicator.

2. Method of claim 1, wherein the volume discount program has the user forecast a total volume of purchased covering material for a given period of time.

3. Method of claim 2 wherein the given period of time is one year.

4. Method of claim 2, wherein the volume discount program is at least two tiered where the identification of volume for a given period of time is the first tier and the second tier is an increase in the total volume of purchased colored material from that of the first period of time in a second similar period of time.

5. Method of claim 2, wherein the forecast includes the monetary amount of application equipment or supplies.

6. Method of claim 4, wherein the volume discount program is administered through a computer system.

7. Method of claim 1 wherein the colored material is paint which is available in types (premium to commercial grade) with at least a range of colors, color consistency from batch to batch, and a range of finishes.

8. Method of claim 1, wherein the improvement in paint efficiency results in at least one of the following: building the business of the painter, growing the margin of the painter's business, driving down costs for the painter's business, and reducing risks for the painter's business.

9. Method of claim 8, wherein the building of the business allows for at least one of: selling more jobs, building reputation, increasing customer satisfaction, increasing referrals, and business diversification.

10. Method of claim 9, wherein the building of the business is accomplished by one or more of providing color visualization software for display on a computer system to simulate the color applied to various surfaces of the building from various paints, project alert system, low odor paint marketability, marketing and advertising assistance.

11. Method of claim 8, wherein growing margin allows for at least one of the following: reduction in call backs, speed project completion, increase margins, reduce downtime, provide proper application.

12. Method of claim 8, wherein drive out costs allows for at least one of reduction in labor costs, reduction in operating costs, improvement in turnover rate of jobs, and improvement of outstanding accounts receivables.

13. Method of claim 8, wherein reduction of risks allows for building reputation, improvement of visual appeal, proper product usage and preparation, and paint occupied spaces with reduced odors.

14. Method of claim 1, wherein the instruction on reducing material and labor costs includes instruction to reduce application time.

15. Method of claim 1, wherein the color matching facilities includes PaintMaker color comparison computer software and computerized color system.

16. Method of claim 1, wherein the color visualization computer software is Previews system to enable builder and contractors to preview different color schemes on their buildings.

17. Method of claim 1, wherein the color matching instruction is monochromatic gray approach of using a gray-shaded base coat underneath a bright, bold and deep color to reduce the number of coats need to obtain the desired coverage.

18. Method of claim 1, which includes providing volume purchase service plan at least two of the following: discounts on office products, car care, and cell phone services.

19. Method of claim 1, which includes a business planning tool to determine paint utilization over a period of time.

20. Method of claim 1, which includes providing at least one of market analysis, business analysis to painting contractors.

21. Method of claim 1, wherein the variety of paint products include advanced alkyd compositions, low VOC compositions, high performance compositions, multipurpose compositions, monotone gray system compositions.

22. Method of claim 1 which includes providing a home builder rewards program.

23. Method of claim 1 which includes providing a business growth planner to the painting contractor.

24. Method of claim 1 which includes providing business analysis and market analysis.

25. Method of claim 1 which includes providing a determine of the right product and service solutions which satisfies the painting contractor's business needs.

26. Method of claim 1 which includes providing group purchasing capability to the painting contractor.

27. A kit for supplying paint and services to the painter, comprising:
job estimator,
bid calculator,
business planning tool to determine paint utilization over a period of time, and color visualization computer software to visualize the utilization of the paint.

28. Method of providing the volume discount paint, comprising:
segmenting the market into provide color tools and services to user that provide inspiration and enhance curb appeal;
provide information and/or instruction for competence in color accuracy and consistency;
provide visual effect software;
provide products and services that save time and improve cycle time/turns of the user; and provide business assistance tools (support home builders sales initiatives).

29. Method of supplying paint materials and services to users through POS outlets, comprising:
a) providing a variety of grades of paint material which is available in types with at least a range of colors, color consistency from batch to batch, and a range of finishes,
b) providing a volume discount program with the purchase of paint materials over time, and
c) providing at least one of:
i) instruction on the efficient utilization of the paint material to reduce labor costs in the application of the paint material,
ii) providing color visualization computer software to visualize the utilization of the paint material,
iii) providing color matching facilities,
iv) providing discount service plan,
v) providing business service assistance, and
vi) providing leads of application jobs for the colored material.
whereby a) through c) lower the cost of paint or shorten the time of application on a per job basis to the painter.
